(19) United States
(12) Patent Application Publication
(10) Pub. No.: US 2018/0359327 A1
(43) Pub. Date: Dec. 13, 2018

(54) ASSEMBLY FOR TRANSMITTING MESSAGES TO SMARTPHONES USERS IN A TERRITORIALLY DELIMITED, TARGET ZONE

(71) Applicant: iSIGN Media Corp., Richmond Hill (CA)

(72) Inventor: Alex Romanov, Goodwood (CA)

(73) Assignee: iiSIGN Media Corp., Richmond Hill (CA)

(21) Appl. No.: 15/784,380

(22) Filed: Oct. 16, 2017

(30) Foreign Application Priority Data
Jun. 9, 2017 (CA) 2965064

(51) Int. Cl. H04L 29/08; H04W 4/02

(52) U.S. Cl. CPC H04L 67/26; H04L 67/18; H04W 4/023

(57) ABSTRACT

The assembly comprises a first subassembly of sensing Smartphones, such as Android Smartphones and iPhone Smartphones, the first subassembly of sensing Smartphones incorporating Wi-Fi sensors and Bluetooth sensors for sensing Smartphones identifiers; a second subassembly incorporating an internet; a third subassembly for storing and conveying messages using a push server with specially developed software for communicating over the second subassembly with the first subassembly; the third subassembly been adapted to be controlled by an operator; a forth proprietary messaging server subassembly for further transmitting messages received over the second subassembly from the third subassembly and pushed to the sensing Smartphones using the second subassembly, namely to each sensing Smartphone; the forth proprietary messaging server subassembly incorporating a Google Cloud Messaging server or an Apple Push Network server and a Cellular Data Network.

### CROSS-REFERENCE TO RELATED APPLICATION

This application claims the benefit of priority on the basis of Canadian Patent Application No. 2965064 filed on Jun. 9, 2017

### I. BACKGROUND OF THE INVENTION

### 1. Definition of the Invention

The present invention relates, in general, to a system that uses Smartphones to receive messages simultaneously from one transmitting system at a chosen time and, more specifically, to an assembly for transmitting messages to Smartphones users in a territorially delimited, targeted zone.

### 2. DESCRIPTION OF THE STATE OF THE ART

The known technique can be used to send to Smartphones users a push message when a promotion, such as a sale, begins, but is not able to identify the specific locations of Smartphones users.

### II. SUMMARY OF THE INVENTION

The first objective of the present invention is to provide a system which can identify simultaneously a number of Smartphones users located in a territorial limited zone.

A second objective of the present invention is to provide a system that sends messages to Smartphones users that are located within a territorial limited zone.

A third objective of the present invention is to provide a system that can be used by multiple stores at the same time.

A fourth objective of the present invention is to provide a system which can support both Android and Apple Smartphone types.

Broadly stating, the assembly for transmitting messages to Smartphones users in a territorially delimited, targeted zone comprises, in combination

a first subassembly of sensing Smartphones, such as Android Smartphones and iPhone Smartphones, the first subassembly for sensing Smartphones being placed within a delimited, targeted zone, wherein shopping malls and/or streets with retail stores, sports arenas or any public environment are located; the first subassembly of sensing Smartphones incorporating Wi-Fi sensors and Bluetooth sensors for sensing Smartphones identifiers;
a second subassembly incorporating an internet;
a third subassembly for storing and conveying messages, such as advertising, promotional or special interest, using a push server with specially developed software for communicating over the second subassembly with the first subassembly, the third subassembly been adapted to be controlled by an operator;
a forth proprietary messaging server subassembly for further transmitting messages received over the second subassembly from the third subassembly and pushed to the sensed Smartphones using the second subassembly, namely to each the sensed Smartphone; the forth proprietary messaging server subassembly incorporating a Google Cloud Messaging server or an and an Apple Push Network server and Cellular Data Network.

In one aspect of the invention when Android Smartphones are sensed, the push server communicates with the Google Cloud Messaging server and instructs the Google Cloud Messaging server to send messages to the Android Smartphones.

In another aspect of the invention in the case when iPhones Smartphones have been sensed, the push server communicates with an Apple Push Network (APN) server and instructs the Apple Push Network (APN) server to send messages to the iPhone Smartphones.

### III. BRIEF DESCRIPTIONS OF THE DRAWINGS

FIG. 1 diagrammatically and generally illustrates an Assembly for Transmitting Messages to Smartphones Users in a Territorially Delimited, Targeted Zone;

FIG. 2 diagrammatically illustrates an Assembly for Transmitting Messages to iPhone Smartphones users in a Territorially Delimited, Targeted Zone; and

FIG. 3 diagrammatically illustrates an Assembly for Transmitting Messages to Android Smartphones Users in a Territorially Delimited, Targeted Zone.

### IV. DESCRIPTION OF THE PREFERRED EMBODIMENTS

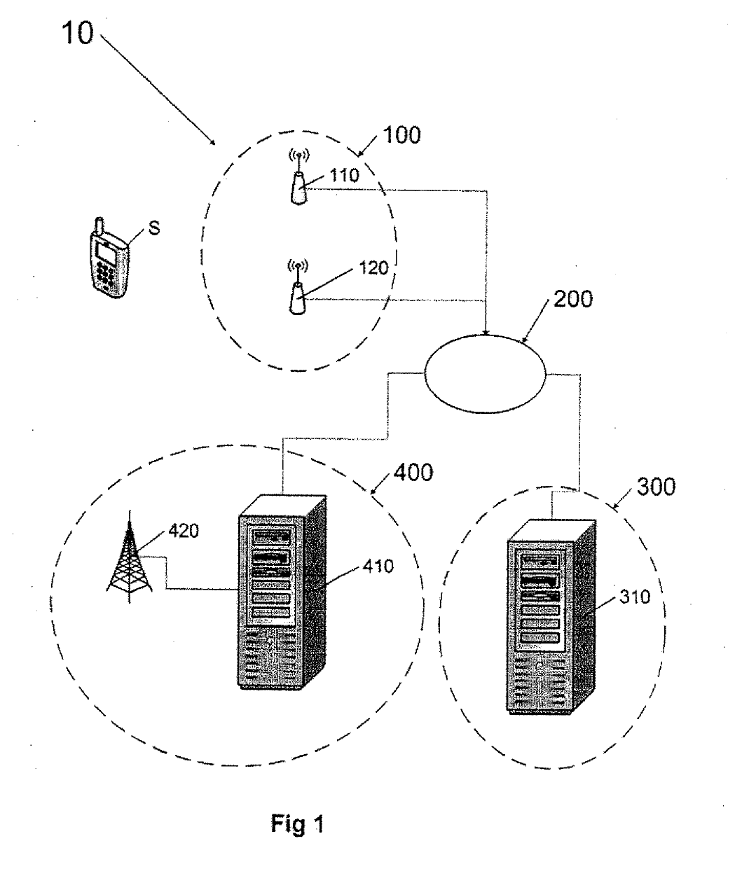

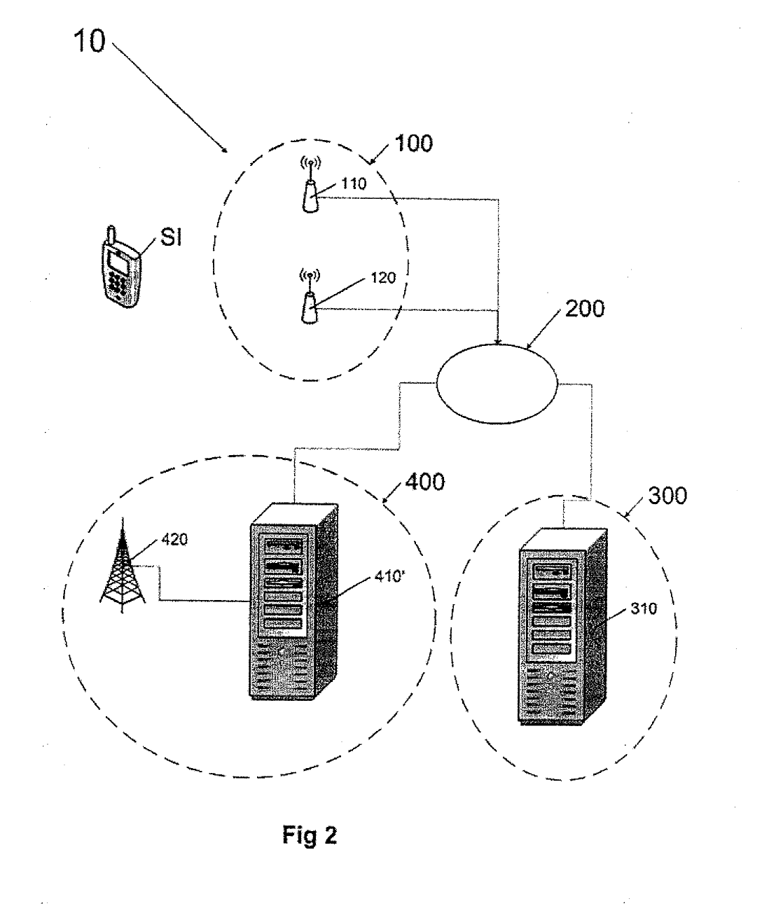

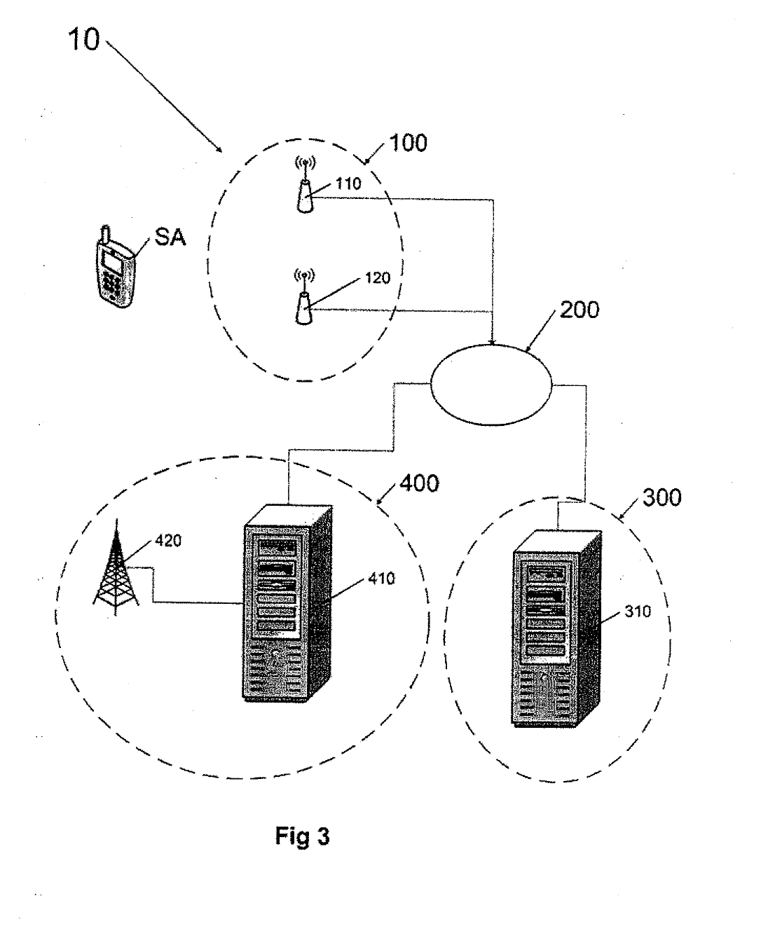

The accompanying FIGS. 1, 2 and 3 illustrate, respectively, a general view and two embodiments of an Assembly for Transmitting Messages to Smartphones Users in a Territorially Delimited, Targeted Zone.

For the simplification of the specification, the foregoing full recitation of the aforementioned assembly will be further replaced by the term “assembly” and referenced by numeral 10.

Assembly 10 comprises, in combination,

A subassembly of sensing Smartphones S, further named “first subassembly” and referenced by numeral 100, is placed within a delimited, targeted zone wherein shopping malls and/or streets with retail stores, sports arenas or any public environment are located; first subassembly 100 incorporates Wi-Fi sensors 110 and Bluetooth sensors 120 for detecting sensing Smartphones S identifiers;

An internet, further named “second subassembly” and referenced by numeral 200;

A subassembly for storing and conveying messages, such as advertising, promotional or of special interest, further named “third subassembly” and referenced by numeral 300, uses a Push Server 310 with specially developed software for communicating over second subassembly 200 with first subassembly 100; third subassembly 300 been adapted to be controlled by an operator;

A proprietary messaging server subassembly for farther transmitting messages, further named “fourth subassembly” and referenced by numeral 400, which messages are received over second subassembly 200 from third subassembly 300 and pushed to sensing Smartphones S using second subassembly 200, namely to each sensing Smartphone S; fourth subassembly 400 incorporating a Google Cloud Messaging 410 and a Cellular Data Network 420;

A plurality of sensing Smartphones S, such as iPhones SI and Android Smartphones SA, for receiving and notifying each user of the plurality of sensing Smartphones S upon reception of advertising/promotional or of special interest messages, received over the second subassembly 200, and ultimately displaying those messages.

Wi-Fi sensors 110 are programmed to sense Wi-Fi probe requests that have been transmitted from nearby sensing Smartphones S and to record a unique sensing Smartphone S Wi-Fi MAC Address that is included within the probe request; newly sensed Smartphones Wi-Fi MAC Addresses being forwarded to Push Server 310; Bluetooth sensors 120 are programmed to scan for sensing Smartphones S that are discoverable using Bluetooth sensors 120 and to record a unique sensing Smartphone S Bluetooth address that is discoverable and to forward newly discovered sensing Smartphones S Bluetooth addresses to Push Server 310.

Smartphone users, following view of a poster or other advertising medium in the specific target zone, agree to receive Push messages from the system by providing either their Wi-Fi MAC Address, Bluetooth Address or both for storage within the system along with a Google Registration ID, for Android Smartphones or device ID, for Apple Smartphones. The Wi-Fi MAC Address will be automatically identified by the Push messaging system when a Wi-Fi connection is made because the system will receive the Wi-Fi MAC address when the connection is made. Users will not need to enter the Wi-Fi MAC Address. The Bluetooth Addresses can be identified by the system and shown to the Smartphone users on their screens, when no other Smartphone users are located close by. To ensure that no other Smartphone users are located nearby, a very small Bluetooth signal is transmitted by the system. After the system stores Wi-Fi MAC Addresses and Bluetooth Addresses, it can begin sensing Smartphones with these addresses to then send messages to those Smartphones.

Then, the Wi-Fi and Bluetooth sensors 110 and 120 will sense that Smartphones such as iPhones SI or Android phones SA are in the targeted zone of the system and will also sense the Wi-Fi MAC address and Bluetooth address of Smartphones S identified. When a Smartphone S is identified, the sensors send the Wi-Fi MAC Address or Bluetooth Address to a Push Server 310.

Push Server 310 will check the Wi-Fi MAC Address or Bluetooth Address to see if it matches an already stored Address and which phone type the address is associated with.

In the case when Android Smartphones SA have been sensed, the Push Server 310 communicates with a Google Cloud Messaging server 410 and instructs the Google Cloud Messaging server 410 to send messages to Android Smartphones SA.

In the case when iPhone Smartphones SI has been sensed, Push Server 310 communicates with a Apple Push Network server 410′ and instructs this Apple Push Network server 410′ to send messages to iPhone Smartphones SI.

The embodiments of the invention in which an exclusive property or privilege is claimed are defined as follows:

1. An assembly for transmitting messages to Smartphones users in a territorially delimited, targeted zone comprising, in combination,
a first subassembly for sensing Smartphones, selected from the group consisting of Android Smartphones and iPhone Smartphones, said first subassembly for sensing Smartphones being placed within a delimited, targeted zone, wherein shopping malls and/or streets with retail stores, sports arenas or any public environment are located; said first subassembly for sensing Smartphones incorporating Wi-Fi sensors and Bluetooth sensors for sensing Smartphones identifiers;
a second subassembly incorporating an internet;
a third subassembly for storing and conveying messages, such as advertising, promotional or of special interest, using a push server with specially developed software for communicating over said second subassembly with said first subassembly; said third subassembly been adapted to be controlled by an operator;
a forth proprietary messaging server subassembly for further transmitting messages received over said second subassembly from said third subassembly and pushed to said sensing Smartphones using said second subassembly, namely to each said sensing Smartphone; said forth proprietary messaging server subassembly incorporating a Google Cloud Messaging and a Cellular Data Network.

2. The assembly, as defined in claim 1, wherein in the case when said Android Smartphones have been sensed, said push server communicates with said Google Cloud Messaging server and instructs said Google Cloud Messaging server to send messages to said Android Smartphones.

3. The assembly, as defined in claim 1, where in the case when said iPhones smartphones have been sensed, said push server communicates with an Apple Push Network server and instructs said Apple Push Network server to send messages to said iPhone Smartphones.
